(19) United States
(12) Patent Application Publication
(10) Pub. No.: US 2009/0058298 A1
(43) Pub. Date: Mar. 5, 2009

(54) PLASMA DISPLAY PANEL AND METHOD OF FABRICATING THE SAME

(76) Inventors: Gun Young Hong, Seoul (KR); Eun A. Moon, Seoul (KR)

Correspondence Address: KED & ASSOCIATES, LLP, P.O. Box 221200, Chantilly, VA, 20153-1200, US

(21) Appl. No.: 12/200,010

(22) Filed: Aug. 28, 2008

(30) Foreign Application Priority Data
Aug. 28, 2007 (KR) 10-2007-0086500

(51) Int. Cl. H01J 17/49; H01J 9/02

(52) U.S. Cl. 313/586; 445/24

(57) ABSTRACT

A plasma display panel and a method of fabricating the same are provided. The plasma display panel may include a first panel having address electrodes, a first dielectric layer, and phosphors all provided with a first and a second panel having transparent electrodes, bus electrodes exhibiting a color that is complementary to a color of the first panel, a second dielectric layer, and a protect layer all provided with a second substrate. The first panel may be coupled to the second panel with barriers positioned therebetween so as to define a plurality of discharge cells.

### This application claims the benefit of Korean Patent Application No. 10-2007-0086500, filed on Aug. 28, 2007, which is hereby incorporated by reference as if fully set forth herein.

### BACKGROUND

1. Field

This relates to a plasma display panel, and more particularly, to a plasma display panel having enhanced color sense and contrast.

2. Background

As the multimedia age emerges, a large-sized display device, which can more finely display colors that are closer to natural colors, is desired. However, cathode ray tubes (CRTs) limit screen size to less than about 40 inches. Thus, high definition liquid crystal displays (LCDs), plasma display panels (PDPs), and projection televisions (TVs) have been rapidly developed to expand capability.

A plasma display panel is an electronic device which displays an image using a plasma discharge. In the plasma display panel, a designated voltage is applied to electrodes disposed in a discharge space such that plasma discharge is carried out therebetween, and phosphors formed in a designated pattern are excited by vacuum ultraviolet rays generated by the plasma discharge, thus forming an image.

However, in the above-described conventional plasma display panel, the phosphors are white phosphors, and have a high reflectivity, thus lowering contrast. Therefore, in order to enhance contrast, a black top is formed on barriers or a black matrix is formed on a front substrate, but these methods do not always achieve a sufficient effect.

Further, current methods of coloring phosphors cannot obtain sufficient light reflectivity. Further, due to the intrinsic characteristics of phosphors to emit light of red, blue and green, the phosphors cannot include sufficient amounts of coloring agent.

### SUMMARY OF THE INVENTION

Accordingly, a plasma display panel and a method of fabricating the same is provided.

One object is to provide a plasma display panel and a method of fabricating the same, in which the amount of white light emitted from phosphors is adjusted to enhance color sense and contrast of the plasma display panel.

To achieve this object and other advantages and in accordance with embodiments broadly described herein, a plasma display panel includes a first panel provided with address electrodes, a first dielectric layer, and phosphors, which are formed on a first substrate; and a second panel provided with transparent electrodes, bus electrodes exhibiting a complementary color of the color of the first panel, a second dielectric layer, and a protect layer, which are formed on a second substrate, and bonded with the first panel such that barriers are interposed between the first and second panels.

In another embodiment, a method of fabricating a plasma display panel includes forming address electrodes, a first dielectric layer, barriers, and phosphors on a first substrate; forming transparent electrodes, bus electrodes exhibiting a complementary color of the color of the first panel, a second dielectric layer, and a protect layer on a second substrate; and bonding the second substrate with the first substrate such that the barriers are interposed between the first and second panels.

It is to be understood that both the foregoing general description and the following detailed description of embodiments as broadly described herein are exemplary and explanatory and are intended to provide further explanation of the invention as claimed.

### BRIEF DESCRIPTION OF THE DRAWINGS

The embodiments will be described in detail with reference to the following drawings in which like reference numerals refer to like elements wherein:

FIG. 1 is a schematic view illustrating a discharge cell structure of a plasma display panel in accordance with an embodiment as broadly described herein;

FIG. 2 is a schematic view illustrating a phosphor of FIG. 1; and

FIGS. 3A to 3K are cross-sectional views illustrating a method of fabricating a plasma display panel in accordance with an embodiment as broadly described herein.

### DETAILED DESCRIPTION

Reference will now be made in detail to various embodiments, examples of which are illustrated in the accompanying drawings.

In the drawings, the thickness of layers and regions are exaggerated for clarity, and the thickness ratio between layers may not necessarily represent the actual thickness ratio.

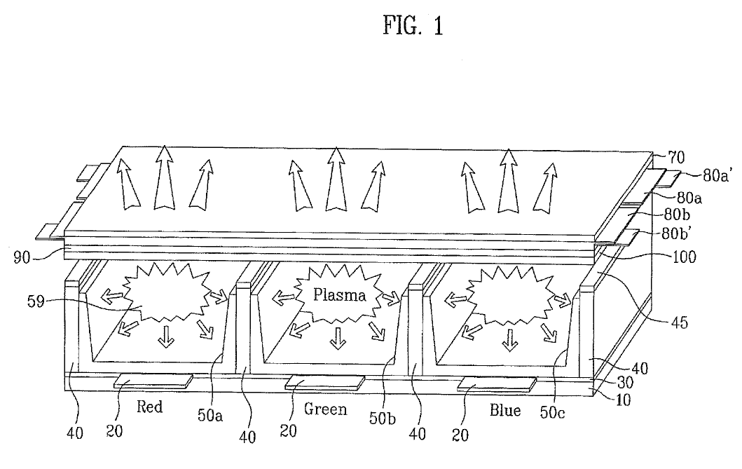

FIG. 1 is a schematic view illustrating a discharge cell structure of a plasma display panel in accordance with an embodiment as broadly described herein. With reference to FIG. 1, a plasma display panel in accordance with this embodiment will be described below.

In the plasma display panel in accordance with this embodiment, sustain electrodes including a pair of transparent electrodes 80a and 80b, which may be made of indium tin oxide (ITO), and a pair of bus electrodes 80a′ and 80b′, which may be made of a metal, are formed on one surface of a front substrate 70, and a dielectric layer 90 and a protect layer 100 covering the sustain electrodes are sequentially formed on the whole surface of the front substrate 70.

The front substrate 70 is formed by milling and cleaning a glass for a display substrate. Further, the transparent electrodes 80a and 80b are formed by a photo-etching method through sputtering or a lift-off method through CVD using indium tin oxide (ITO) or SnO₂. The bus electrodes 80a′ and 80b′ may include silver (Ag), and other materials as appropriate.

The bus electrodes 80a′ and 80b′ may exhibit a complementary color of the color of a lower panel provided with a rear substrate 10. For example, in case that the lower panel is red-colored by coating red phosphors with a pigment, the bus electrodes 80a′ and 80b′ may be blue-colored so that the color sense of the plasma display panel is not lowered. The bus electrodes 80a′ and 80b′ include silver (Ag) and a pigment. Here, the pigment causes the bus electrodes 80a′ and 80b′ to exhibit a color, and the detailed raw materials of the pigment differ according to the color. Further, a black matrix is formed on the pair of the sustain electrodes, and includes a low-melting point glass, a black pigment, etc.

The upper dielectric layer 90 is formed on the front substrate 70, on which the transparent electrodes 80a and 80b and the bus electrodes 80a′ and 80b are formed. Here, the upper electric layer 90 includes a transparent low-melting point glass. Further, the protect layer 100 made of magnesium oxide is formed on the upper dielectric layer 90, and thus protects the upper dielectric layer 90 from an impact of positive ions while discharging and increases emission of secondary electrons.

Address electrodes 20, which are disposed in a direction intersecting the transparent and bus electrodes 80a, 80b, 80a′ and 80b′, are formed on one surface of the rear substrate 10, and a white dielectric layer 30 covering the address electrodes 20 is formed on the whole surface of the rear substrate 10. The white dielectric layer 30 formed on the whole surface of the rear substrate 10 includes a low-melting point glass, a filler, such as TiO₂, and other materials as appropriate. The white dielectric layer 30 is stacked on the whole surface of the rear substrate 10 by a printing method or a film-laminating method, and is baked.

Barriers 40 are formed on the white dielectric layer 30 such that the barriers 40 are disposed between the respective address electrodes 20. The barriers 40 may have various types including a stripe-type, a well-type, or a delta-type. A black top may be provided on the barriers 40 to enhance contrast. Further, red (R), green (G), and blue (B) phosphors 50a, 50b, and 50c are injected into spaces between the respective barriers 40.

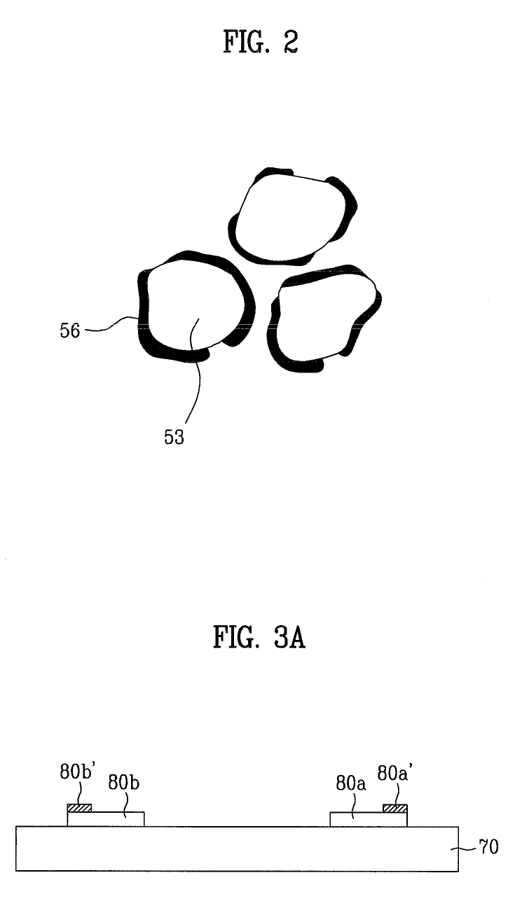

Here, contact-enhanced phosphors (CEPs) may be used as the red (R), green (G), and blue (B) phosphors 50a, 50b, and 50c. As shown in FIG. 2, the CEPs are obtained by stacking or coating a pigment 56 on the surfaces of fluorescent materials 53. Each of the fluorescent materials 53 may have a size of approximately 0.1˜20 μm. Here, the size corresponds to an approximate diameter of each of the fluorescent materials 53 in the case that particles of the fluorescent materials 53 have a spherical shape, and corresponds to an approximate length of one side of each of the fluorescent materials 53 in the case that the particles of the fluorescent material 53 have a hexahedral shape. The pigment 56 to enhance contrast is stacked on the surfaces of the fluorescent materials 53, which are excited by vacuum ultraviolet rays generated by plasma discharge and emit red, green, and blue visible rays.

The pigment 56 exhibits a color, which is equal or similar to red, green, or blue emitted by each of the fluorescent materials 53, in order to enhance contrast. Thus, the pigment 56 exhibiting the above-described color is coated onto the surface of each of the fluorescent materials 53 or added to a fluorescent film of each of the fluorescent materials 53. Further, a black pigment may be used. However, the black pigment may lower light reflectivity.

The phosphors 50a, 50b, and 50c may produce high color purity of red, green, and blue emitted therefrom, and high thermal stability during processing and operation. The phosphors 50a, 50b, and 50c may also have excellent durability to ultraviolet rays generated from the operation of the panel and ion collision, and thus have a long life span. In order to provide these characteristics, (Y, Gd)BO₃:Eu is used as the fluorescent material emitting red. Zn₂SiO₄:Mn or YBO₃:Tb is used as the fluorescent material emitting green. BaMgAl₁₀O₁₇:Eu is used as the fluorescent material emitting blue. Further, CoAl₂O₄, Co—Cr—Ti—Al oxide, or Fe₂O₃ is used as the pigment deposited on the surface of each of the above-described fluorescent materials. Particularly, the pigment allows red emitted from the red fluorescent material to be clear, and thus allows the bus electrodes to exhibit blue, as described above.

In addition to the above substance, Y₂O₃:Eu, Y₂SiO₂:Eu, or Y₃Al₅O_{12:}Eu may be used as the red fluorescent material. In addition to the above substance, CaAl₁₂O₁₉:Mn, or ScBO₃:Tb may be used as the green fluorescent material. In addition to the above substance, CaWO₄:Pb, Y₂SiO₅:Ce, or BaMgAl₁₄O₂₃:Eu may be used as the blue fluorescent material. These substances are only examples of the fluorescent materials, and various fluorescent materials emitting visible rays of red, green, and blue may be used.

When the amount of the pigment is excessively large, the pigment may change the intrinsic colors emitted from the fluorescent materials. Preferably, the amount of the pigment does not exceed 30% of the amount of each of the fluorescent materials.

An inert gas, such as helium (He), neon (Ne), xenon (Xe), or the like, which is used as a discharge gas 59, is injected into each of discharge cells. Here, the discharge cells are divided from each other by intersecting points between the address electrodes 20 on the rear substrate 10 and the sustain electrodes on the front substrate 70.

Hereinafter, the operation of the above plasma display panel in accordance with one embodiment will be described.

Address voltage is applied to a space between the address electrodes 20 and one sustain electrode to generate an address discharge, and thus wall voltage is formed in discharge cells in which the discharge is generated. Then, sustain voltage is applied to a gap between the pair of the sustain electrodes to generate sustain discharge in the discharge cells in which the wall voltage is formed. Vacuum ultraviolet rays generated by the sustain discharge excite the fluorescent materials such that the fluorescent materials emit light of respective colors, and thus visible rays are emitted through the front substrate 70 to form an image on the plasma display panel. Here, the pigment 56 is coated on the surface of each of the fluorescent materials 53, and prevents white light from being reflected by the surfaces of the fluorescent materials 53, thus enhancing contrast. Further, due to the use of the pigment 56, light of a specific wavelength emitted from the discharge cells becomes clearer and the bus electrodes 80a′ and 80b′ on the front substrate 70 exhibit a complementary color of the light of the specific wavelength, and thus it is possible to prevent the lowering of color sense.

Further, although not shown in the drawings, a front filter may be provided on the front substrate 70, and serve to shield electronic waves and near infrared rays emitted from the inside of the panel, reflect external light, and perform color correction.

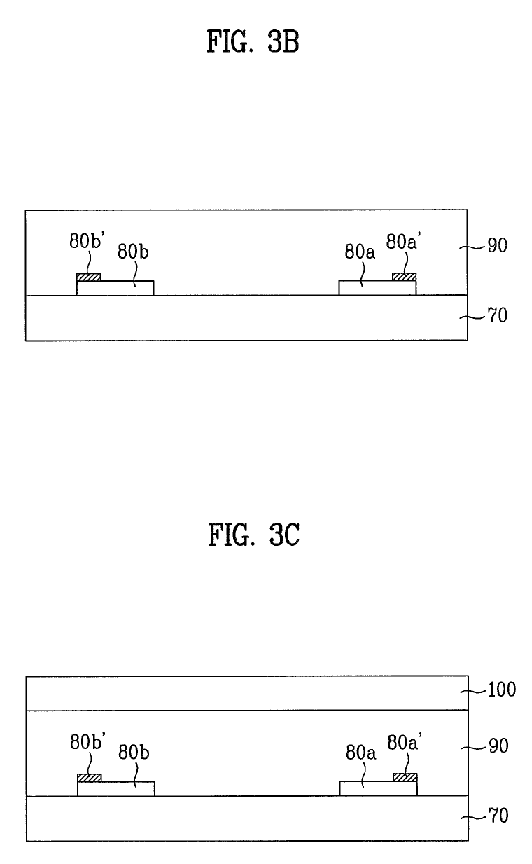

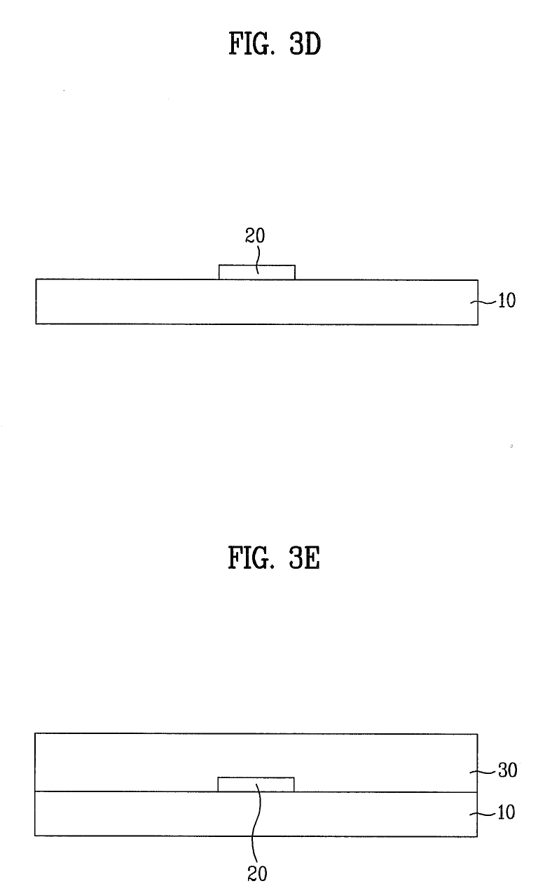

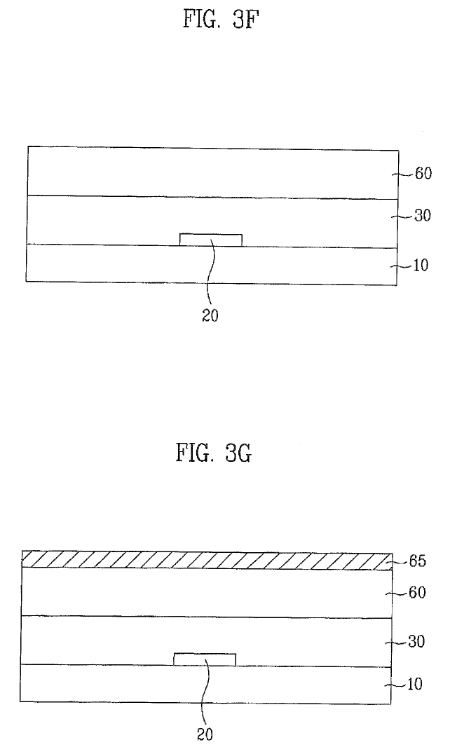

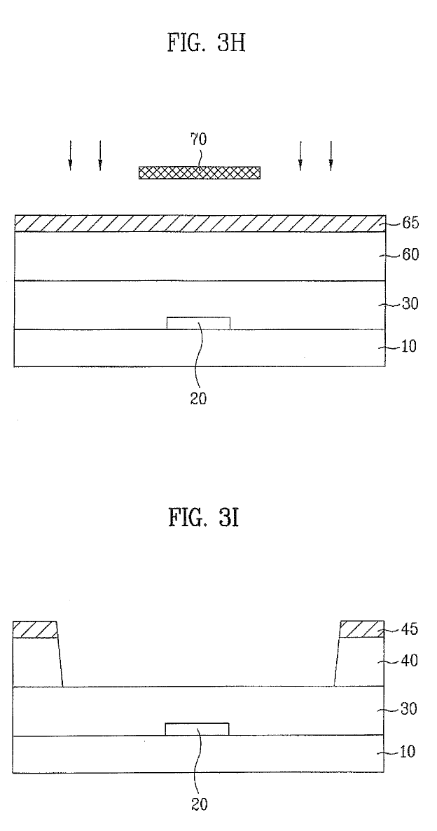

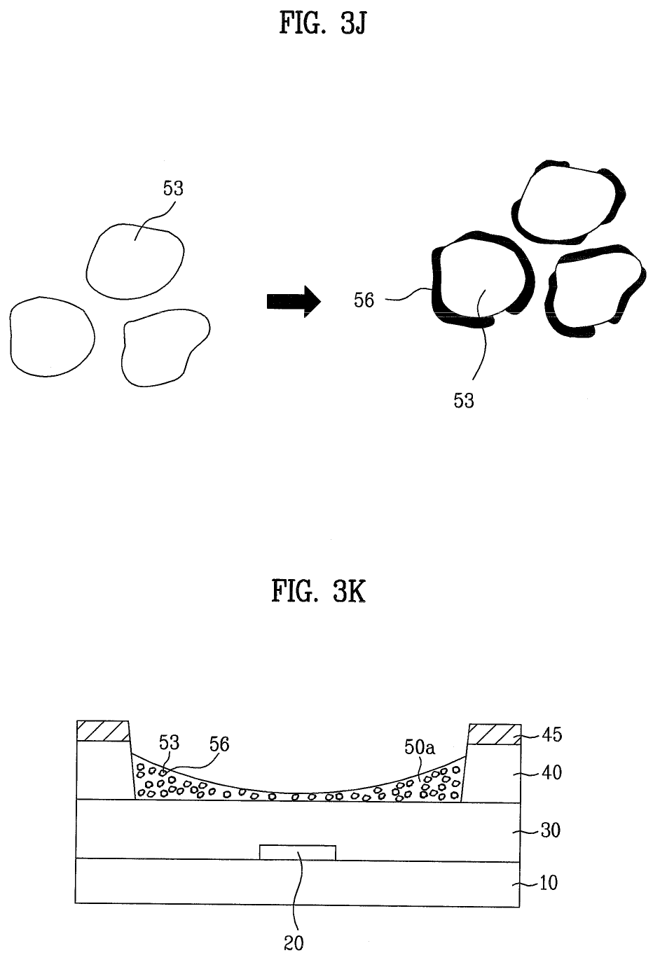

FIGS. 3A to 3K are cross-sectional views illustrating a method of fabricating a plasma display panel in accordance with one embodiment as broadly described herein. Hereinafter, with reference to FIGS. 3A to 3K, the method of fabricating a plasma display panel in accordance with one embodiment will be described.

First, as shown in FIG. 3A, transparent electrodes 80a and 80b and bus electrodes 80a′ and 80b′ are formed on a front substrate 70. The front substrate 70 is manufactured by milling and cleaning a glass for a display substrate or a soda-lime glass. The transparent electrodes 80a and 80b are formed by a photo-etching method through sputtering or a lift-off method through CVD using ITO or SnO₂. Further, the bus electrodes 80a′ and 80b′ are formed by a screen printing method or a photosensitive paste method using a material including silver (Ag) and a pigment. Here, CoAl₂O₄, Co—Cr—Ti—Al oxide, or Fe₂O₃ is used as the pigment 53, and the pigment 53 is varied according to the color of the bus electrodes 80a′ and 80b′.

Further, a black matrix (not shown) may be formed on the pair of the sustain electrodes. The black matrix is formed by a screen printing method or a photosensitive paste method using a low-melting point glass and a black pigment.

Thereafter, as shown in FIG. 3B, a dielectric layer 90 is formed on the front substrate 70 provided with the transparent electrodes 80a and 80b and the bus electrodes 80a′ and 80b′. Here, the dielectric layer 90 is stacked on the front substrate 70 by a screen printing method, a coating method, or a green sheet-laminating method using a material including a low-melting point glass.

Thereafter, as shown in FIG. 3C, a protect layer 100 is deposited on the dielectric layer 90. Here, the protect layer 100 is formed by an electronic beam- depositing method, a sputtering method, or an ion-plating method using magnesium oxide.

Thereafter, as shown in FIG. 3D, address electrodes 20 are formed on a rear substrate 10. Here, the rear substrate 10 is manufactured by milling and cleaning a glass for a display substrate or a soda-lime glass. Then, the address electrodes 20 are formed on the rear substrate 10. The address electrodes 20 are formed by a screen printing method, a photosensitive paste method, or a photo-etching method after sputtering using silver (Ag), and other materials as appropriate.

Thereafter, as shown in FIG. 3E, a dielectric layer 30 is formed on the rear substrate 10 provided with the address electrodes 20. The dielectric layer 30 is formed by a screen printing method or a green sheet-laminating method using a material including a low-melting point glass and a filler, such as TiO₂. Here, the dielectric layer 30 may be white in order to increase the brightness of the plasma display panel.

Thereafter, barriers 40 for dividing respective discharge cells from each other are formed. Here, as shown in FIG. 3F, a barrier material 60 is applied to the dielectric layer 30. The barrier material 60 includes a parent glass and a filler. The glass includes PbO, SiO₂, B₂O₃, and Al₂O₃, and the filler includes TiO₂ and Al₂O₃.

Thereafter, as shown in FIG. 3G, a black top material 65 is applied to the barrier material 60. Here, the black top 65 material includes a solvent, an inorganic powder, and an additive. Further, the inorganic powder includes a glass frit and a black pigment.

Thereafter, as shown in FIG. 3H, the barrier material 60 and the black top material 65 are selectively patterned using a mask 70 to form barriers 40 and black tops 45 as shown in FIG. 31.

Here, the patterning of the barrier material 60 and the black top material 65 is achieved by exposing the barrier material 60 and the black top material 65 to light using the mask 70, and developing the barrier material 60 and the black top material 65. That is, when the rear substrate 10 is exposed to light when the mask 70 having a pattern corresponding to the address electrodes 20 is located above the rear substrate 10, only portions of the barrier material 60 and the black top material 65, onto which light is irradiated, remain after developing and baking, and thus form the barriers 40 and the black tops 45. In a case in which the black top material 65 includes a photoresist, the patterning of the barrier material 60 and the black top material 65 is easily achieved. Further, when the barrier material 60 and the black top material 65 are baked together, the bonding strength of the parent glass of the barrier material 60 with the inorganic powder of the black top material 65 is increased and thus the strengthening and durability of the resulting barriers 40 is provided.

Thereafter, as shown in FIG. 3J, phosphors are prepared. CEPs may be formed by depositing a pigment 56 on the surface of each of fluorescent materials 53. In alternative embodiments, the phosphors may be formed by mixing the pigment 56 with a fluorescent film on the surface of each of the fluorescent materials 53. As described above, (Y, Gd)BO₃:Eu is used as the fluorescent material emitting red. Zn₂SiO₄:Mn is used as the fluorescent material emitting green. BaMgAl₁₀O₁₇:Eu is used as the fluorescent material emitting blue. Further, CoAl₂O₄, Co—Cr—Ti—Al oxide, or Fe₂O₃ is used as the pigment deposited on the surface of each of the above-described fluorescent materials.

Thereafter, as shown in FIG. 3K, CEPs 50a are applied to the surface of the dielectric layer 30 contacting a discharge space and the side surfaces of the barriers 40. Here, R, G, and B phosphors are sequentially applied according to the respective discharge cells by a screen printing method or a photosensitive paste method. When the phosphors are stacked by the screen printing method, the R, G, and B phosphors are independently printed and thus a printing process is performed three times. Further, when a photosensitive paste is used, the photosensitive paste is applied by an inkjet method. Here, the fluorescent materials may include an organic solvent, a binder, and the like, but the organic solvent may be substantially completely removed after drying and/or baking.

Thereafter, the upper panel is bonded to the lower panel such that the barriers 40 are interposed therebetween, and a gap between the upper and lower panels is sealed. Then, internal impurities are discharged to the outside, and then a discharge gas 59 is injected into respective discharge cells. Further, a front filter may be formed on the surface of the front substrate 70.

The above-described plasma display panel and the method of fabricating the same use CEPs obtained by depositing a pigment on the surface of each of the fluorescent materials, and thus prevent white light from being discharged to the outside, thereby enhancing the contrast of the plasma display panel.

Further, the bus electrodes of the upper panel complement a specific color exhibited by the lower panel due to the CEPs, and thus the color sense of the plasma display panel is enhanced.

It will be apparent to those skilled in the art that various modifications and variations can be made to the embodiments broadly described herein without departing from the intended spirit or scope thereof. Thus, it is intended that the embodiments as broadly described herein cover such modifications and variations provided they come within the scope of the appended claims and their equivalents.

Any reference in this specification to “one embodiment,” “an embodiment,” “example embodiment,” “certain embodiment,” “alternative embodiment,” etc., means that a particular feature, structure, or characteristic described in connection with the embodiment is included in at least one embodiment as broadly described herein. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A plasma display panel, comprising:
a first panel including address electrodes, a first dielectric layer, and phosphors, each provided on a first substrate; and
a second panel including transparent electrodes, bus electrodes that generate a color that is complementary to a color of the first panel, a second dielectric layer, and a protective layer provided on a second substrate; and
a plurality of barriers interposed between the first and second panels so as to define a plurality of discharge cells therebetween.

2. The plasma display panel according to claim 1, wherein the color of the first panel is determined by respective phosphors provided in the plurality of discharge cells.

3. The plasma display panel according to claim 1, wherein each of the phosphors includes a fluorescent material and a pigment provided on an exterior surface of the fluorescent material.

4. The plasma display panel according to claim 3, wherein a fluorescent material provided in red discharge cells of the plurality of discharge cells is selected from the group consisting of (Y, Gd)BO₃:Eu, Y₂O₃:Eu, Y₂SiO₂:Eu, and Y₃Al₅O₁₂:Eu.

5. The plasma display panel according to claim 3, wherein a fluorescent material provided in green discharge cells of the plurality of discharge cells is selected from the group consisting of YBO₃:Tb, CaAl₁₂O₁₉:Mn, ScBO₃:Tb, and Zn₂SiO₄:Mn.

6. The plasma display panel according to claim 3, wherein a fluorescent material provided in blue discharge cells of the plurality of discharge cells is selected from the group consisting of CaWO₄:Pb, Y₂SiO₅:Ce, BaMgAl₁₄O₂₃:Eu and BaMgAl₁₀O₁₇:Eu.

7. The plasma display panel according to claim 3, wherein the pigment provided on the surface of the fluorescent material includes one selected from the group consisting of CoAl₂O₄, Co—Cr—Ti—Al oxide, and Fe₂O₃.

8. The plasma display panel according to claim 1, wherein the bus electrodes generate a blue color, and the first panel generates a red color.

9. A plasma display panel, comprising:
a first panel, comprising:
a first substrate;
address electrodes provided on the first substrate;
a first dielectric layer provided on the first substrate; and
a plurality of barrier ribs provided on the first dielectric layer;
a second panel, comprising;
a second substrate;
transparent electrodes provided on the first substrate;
bus electrodes provided on the transparent electrodes;
a second dielectric layer provided on the transparent electrodes, bus electrodes and second substrate; and
a protect layer provided on the second dielectric layer, wherein the second panel is bonded with the first panel, with the plurality of barrier ribs positioned therebetween so as to define a plurality of discharge cells; and
a plurality of phosphors, each including a fluorescent material and a pigment, provided in each of the plurality of discharge cells.

10. The plasma display panel according to claim 9, wherein the pigment includes one selected from the group consisting of CoAl₂O₄, Co—Cr—Ti—Al oxide, and Fe₂O₃.

11. The plasma display panel according to claim 9, wherein a fluorescent material selected from the group consisting of (Y, Gd)BO₃:Eu, Y₂O₃:Eu, Y₂SiO₂:Eu, and Y₃Al₅O₁₂:Eu, and a pigment, are provided in red discharge cells of the of the plurality of discharge cells.

12. The plasma display panel according to claim 9, wherein a fluorescent material selected from the group consisting of YBO₃:Tb, CaAl₁₂O₁₉Mn, ScBO₃:Tb, and Zn₂SiO₄:Mn, and a pigment, are provided in green discharge cells of the plurality of discharge cells.

13. The plasma display panel according to claim 9, wherein a fluorescent material selected from the group consisting of CaWO₄:Pb, Y₂SiO₅:Ce, BaMgAl₁₄O₂₃:Eu and BaMgAl₁₀O₁₇:Eu, and a pigment, are provided in blue discharge cells of the plurality of discharge cells.

14. The plasma display panel according to claim 9, wherein the bus electrodes exhibit a color that is complementary to a color of the first panel.

15. A method of fabricating a plasma display panel, the method comprising:
providing address electrodes, a first dielectric layer, barriers, and phosphors on a first substrate to form a first panel;
providing transparent electrodes, bus electrodes exhibiting a color that is complementary to a color of the first panel, a second dielectric layer, and a protect layer on a second substrate to form a second panel; and
bonding the second substrate with the first substrate such that the barriers are interposed between the first and second panels.

16. The method according to claim 15, wherein providing phosphors on the first substrate includes:
preparing phosphors including a fluorescent material and a pigment; and
injecting the phosphors into discharge cells defined by the barriers on the first substrate.

17. The method according to claim 16, wherein preparing the phosphors comprises preparing fluorescent materials, and coating a pigment including one selected from the group consisting of CoAl₂O₄, Co—Cr—Ti—Al oxide, and Fe₂O₃ on the surface of each of the fluorescent materials, or mixing the pigment with a fluorescent film on each of the fluorescent materials.

18. The method according to claim 16, wherein injecting the phosphors into discharge cells comprises performing a pattern printing method or a photosensitive paste method to apply the phosphors to the discharge cells.

19. The method according to claim 15, wherein providing bus electrodes on the first substrate comprises sputtering the bus electrodes onto the first substrate using a pattern printing method, a photosensitive paste method, or a photo-etching method.

20. The method according to claim 15, wherein the bus electrodes include silver and a blue pigment.
